(19) United States
(12) Patent Application Publication
(10) Pub. No.: US 2026/0001131 A1
(43) Pub. Date: Jan. 1, 2026

(54) THREE-DIMENSIONAL PRINTING WITH AUSTENITIC STEEL PARTICLES

(71) Applicant: PERIDOT PRINT LLC, Palo Alto, CA (US)

(72) Inventors: Mackensie Cathryn Smith, Corvallis, OR (US); James McKinnell, Corvallis, OR (US); Pavan Suri, Corvallis, OR (US)

(21) Appl. No.: 19/318,273

(22) Filed: Sep. 3, 2025

Related U.S. Application Data
(63) Continuation of application No. 17/628,919, filed on Jan. 21, 2022.

(51) Int. Cl. B22F 10/14; B22F 1/06; B22F 10/64; B22F 12/13; B22F 12/30; B22F 12/50; B33Y 10/00; B33Y 30/00; B33Y 70/00; C22C 38/00; C22C 38/02; C22C 38/04; C22C 38/44; C22C 38/52

(52) U.S. Cl. CPC B22F 10/14; B22F 1/06; B22F 10/64; B22F 12/13; B22F 12/30; B33Y 10/00; B33Y 30/00; B33Y 70/00; C22C 38/001; C22C 38/02; C22C 38/04; C22C 38/44; C22C 38/52; B22F 12/50; B22F 2301/35; B22F 2304/10

(57) ABSTRACT

A three-dimensional printing kit can include a binding agent including a binder in a liquid vehicle and a particulate build material including from about 80 wt % to 100 wt % stainless steel particles having a D50 particle size from about 5 μm to about 125 μm. From about 75 wt % to 100 wt % of the stainless steel particles can be austenitic stainless steel particles including from about 10 wt % to about 12.3 wt % nickel, from 10 about 10 wt % to about 20 wt % chromium, from about 1.5 wt % to about 4 wt % molybdenum, and up to about 0.08 wt % carbon. The austenitic stainless steel particles can have an equivalent nickel content from about 10 wt % to about 15.5 wt %.

### CROSS REFERENCE TO RELATED APPLICATIONS

This application is a continuation of U.S. application Ser. No. 17/628,919, filed Jan. 21, 2022, which itself is a 371 National Stage Entry of International Application No. PCT/US2019/049651, filed Sep. 5, 2019, each of which is incorporated herein by reference in its entirety.

### BACKGROUND

Three-dimensional (3D) printing may be an additive printing process used to make 3D solid parts from a digital model. 3D printing is often used in rapid product prototyping, mold generation, mold master generation, and short run manufacturing. Some 3D printing techniques are considered additive processes because they involve the application of successive layers of material. This is unlike other machining processes, which often rely upon the removal of material to create the final part. Some 3D printing methods use chemical binders or adhesives to bind build materials together. Other 3D printing methods involve partial sintering, melting, etc. of the build material. For some materials, partial melting may be accomplished using heat-assisted extrusion, and for some other materials curing or fusing may be accomplished using, for example, ultra-violet light or infrared light.

### BRIEF DESCRIPTION OF THE DRAWINGS

FIG. 1 graphically illustrates an example three-dimensional (3D) printing kit in accordance with the present disclosure;

FIG. 2 graphically illustrates an example 3D printing system in accordance with the present disclosure;

FIG. 3 graphically illustrates an example 3D printing system in accordance with the present disclosure;

FIG. 4 is a flow diagram illustrating an example method of 3D printing in accordance with the present disclosure; and

FIG. 5 is a graph showing an example data set illustrating the relationship between article density, nickel content, and equivalent nickel content in accordance with the present disclosure.

### DETAILED DESCRIPTION

Three-dimensional (3D) printing can be an additive process involving the application of successive layers of particulate build material with binding agent printed thereon to bind the successive layers of the particulate build materials together. In some processes, application of a binding agent with a binder therein can be utilized to form a green body object or article and then a heat-fused 3D article can be formed therefrom, such as by sintering, annealing, melting, etc. More specifically, a binding agent can be selectively applied to a layer of a particulate build material on a support bed, e.g., a build platform supporting particulate build material, to pattern a selected region of a layer of the particulate build material and then another layer of the particulate build material can be applied thereon. The binding agent can be applied again, and then repeated to form the green part (also known as a green body object or a green body article), which can then be heat-fused to form the fused 3D article. In 3D printing with stainless steel particles, small cavities, e.g. pores, can form in the green body object during printing. The quantity of pores can be related to the density of the heat-fused article formed therefrom. Green body articles that have more pores and large pores can lead to heat-fused articles that are less dense than articles formed from green body articles with fewer pores and/or smaller pores. Lower densities sometimes lead to lower mechanical strength, including articles that are often subject to material fatigue and/or cracking.

In accordance with this, a three-dimensional printing kit can include a binding agent including a binder in a liquid vehicle, and a particulate build material including from about 80 wt % to 100 wt % stainless steel particles having a D50 particle size from about 5 μm to about 125 μm, with about 75 wt % to 100 wt % of the stainless steel particles being austenitic stainless steel particles. The austenitic stainless steel particles can include from about 10 wt % to about 12.3 wt % nickel, from about 10 wt % to about 20 wt % chromium, from about 1.5 wt % to about 4 wt % molybdenum, and up to about 0.08 wt % carbon. Furthermore, the austenitic stainless steel particles can have an equivalent nickel content from about 10 wt % to about 15.5 wt %. Equivalent nickel content is not the same as nickel content, and is described in greater detail hereinafter. In one example, the stainless steel particles can include from 0.1 wt % to about 10 wt % ferritic steel grains, martensitic steel grains, amorphous steel grains, or a combination thereof, in addition to the austenitic stainless steel particles. In another example, the austenitic stainless steel particles can include up to about 0.03 wt % carbon. The austenitic stainless steel particles can likewise include from 0 wt % to about 2 wt % manganese, from 0 wt % to about 1 wt % cobalt, from 0 wt % to about 0.03 wt % carbon, from 0 wt % to about 0.08 wt % nitrogen, and from 0 wt % to about 2 wt % silicon. In another example, chromium can be present in the austenitic stainless steel at from about 16 wt % to about 18 wt %, the molybdenum can be present in the austenitic stainless steel at from about 2 wt % to about 3 wt %, or both within these ranges can be present in the austenitic stainless steel. The stainless steel particles can have, for example, a D50 particle size from about 5 μm to about 75 μm. In further detail, the binder can be a latex binder and the binding agent can include from about 2 wt % to about 30 wt % latex particles.

In another example, a three-dimensional printing system can include a binding agent including a binder in a liquid vehicle and a particulate build material including from about 80 wt % to 100 wt % stainless steel particles having a D50 particle size from about 5 μm to about 125 μm, with about 75 wt % to 100 wt % of the stainless steel particles being austenitic stainless steel particles. The austenitic stainless steel particles can include from about 10 wt % to about 12.3 wt % nickel, from about 10 wt % to about 20 wt % chromium, from about 1.5 wt % to about 4 wt % molybdenum, and up to about 0.08 wt % carbon. Furthermore, the austenitic stainless steel particles can have an equivalent nickel content from about 10 wt % to about 15.5 wt %. The system can further include a fluid applicator fluidly coupled or coupleable to the binding agent to apply the binding agent to the particulate build material to form a layered green body article. In one example, the system can include a build platform to support the particulate build material. The build platform can thus be positioned to receive the binding agent from the fluid applicator onto a layer of the particulate build material. In further detail, the system can also include a fusing oven to heat the green body article and form a fused three-dimensional article.

In another example, a method of three-dimensional printing can include iteratively applying individual build material layers of a particulate build material, and based on a 3D article model, iteratively applying a binding agent to individual build material layers to define individually patterned article layers that become adhered to one another to form a layered green body article. The particulate build material can include from about 80 wt % to 100 wt % stainless steel particles having a D50 particle size from about 5 μm to about 125 μm. About 75 wt % to 100 wt % of the stainless steel particles can be austenitic stainless steel particles including from about 10 wt % to about 12.3 wt % nickel, from about 10 wt % to about 20 wt % chromium, from about 1.5 wt % to about 4 wt % molybdenum, and up to about 0.08 wt % carbon. The austenitic stainless steel particles can have an equivalent nickel content from about 10 wt % to about 15.5 wt %. The green body article can have a porosity ranging from about 38% to about 50% by volume. The method can further include heat fusing the green body article to a temperature ranging from about 1,250° C. to about 1,430° C. for a time period ranging from about 10 minutes to about 10 hours to form a fused three-dimensional article. The fused three-dimensional article can have a theoretical density of from about 95% to 100%. In further detail, the method can include pre-heating the green body article to within a temperature ranging from about 300° C. to about 600° C. for a time period ranging from about 5 minutes to 20 hours prior to heat fusing the green body article.

When discussing the three-dimensional (3D) printing kit, the 3D printing system, and/or the method of 3D printing herein, these discussions can be considered applicable to one another whether or not they are explicitly discussed in the context of that example. Thus, for example, when discussing stainless steel particles related to a 3D printing kit, such disclosure is also relevant to and directly supported in the context of the 3D printing system, the method of 3D printing, and vice versa.

Terms used herein will have the ordinary meaning in their technical field unless specified otherwise. In some instances, there are terms defined more specifically throughout the specification or included at the end of the present specification, and thus, these terms can have a meaning as described herein.

### Three-Dimensional Printing Kits

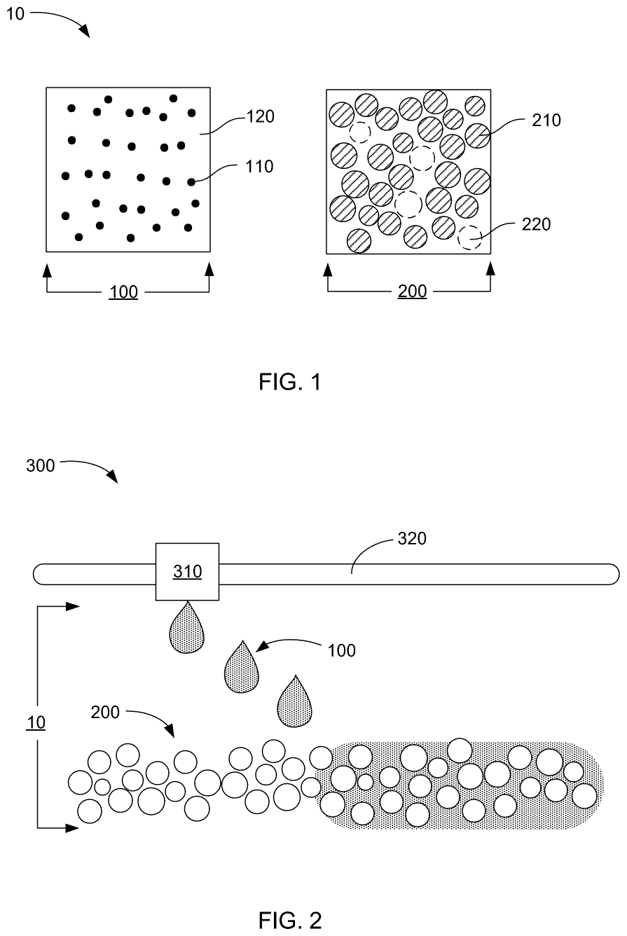

In accordance with examples of the present disclosure, a three-dimensional (3D) printing kit 10 is shown in FIG. 1. The 3D printing kit can include a binding agent 100 and a particulate build material 200. The binding agent can include a binder 110 in a liquid vehicle 120. The particulate build material can include, by way of example, from about 80 wt % to 100 wt % stainless steel particles having a D50 particle size from about 5 μm to about 125 μm, with about 75 wt % to 100 wt % of the stainless steel particles being austenitic stainless steel particles 210. The austenitic stainless steel particles can include from about 10 wt % to about 12.3 wt % nickel, from about 10 wt % to about 20 wt % chromium, from about 1.5 wt % to about 4 wt % molybdenum, and up to about 0.08 wt % carbon. Furthermore, the austenitic stainless steel particles can have an equivalent nickel content from about 10 wt % to about 15.5 wt %. If there are other types of stainless steel particles 220 present, they are represented by dashed lines in FIG. 1. For example, some of the particles may be ferritic steel grains, martensitic steel grains, and/or amorphous steel grains, if included. The particulate build material may be packaged or co-packaged with the binding agent in separate containers, and/or can be combined with the binding agent at the time of printing, e.g., loaded together in a 3D printing system.

### Binding Agents

In further detail, regarding the binding agent 100 that may be present in the three-dimensional (3D) printing kit, the 3D printing system, or utilized in the method of 3D printing as described herein, the binding agent can include a liquid vehicle 120 and binder 110 to bind the particulate build material together during the build process to form a 3D green body article. The term “binder” can include any material used to physically bind separate stainless steel particles together or facilitate adhesion to a surface of adjacent stainless steel particles in order to prepare a green part or green body article in preparation for subsequent heat-fusing, e.g., sintering, annealing, melting, etc. During 3D printing, a binding agent can be applied to the particulate build material on a layer by layer basis. The liquid vehicle of the binding agent can be capable of wetting a particulate build material and the binder can move into vacant spaces between stainless steel particles of the particulate build material, for example.

The binding agent can provide binding to the particulate build material upon application, or in some instances, can be activated after application to provide binding. The binder can be activated or cured by heating the binder (which may be accomplished by heating an entire layer of the particulate build material on at least a portion of the binding agent which has been selectively applied). If the binder is a polymer binder, then this may occur at about the glass transition temperature of the binder, for example. When activated or cured, the binder can form a network that adheres or glues the stainless steel particles of the particulate build material together, thus providing cohesiveness in forming and/or holding the shape of the green body article or a printed layer thereof. A “green” part or green body article (or individual layer) can refer to any component or mixture of components that are not yet sintered or annealed, but which are held together in a manner sufficient to permit heat-fusing, e.g., handling, moving, or otherwise preparing the part for heat-fusing.

Thus, in one example, the green body article can have the mechanical strength to withstand extraction from a powder bed and can then be sintered or annealed to form a heat-fused article. Once the green part or green body article is sintered or annealed, is herein referred to as a “heat-fused” article, part, or object. The term “sinter” or “sintering” refers to the consolidation and physical bonding of the stainless steel particles together (after temporary binding using the binding agent) by solid state diffusion bonding, partial melting of stainless steel particles, or a combination of solid state diffusion bonding and partial melting. The term “anneal” or “annealing” refers to a heating and cooling sequence that controls the heating process and the cooling process, e.g., slow cooling in some instances can remove internal stresses and/or toughen the heat-fused part or article. In some examples, the binder contained in the binding agent can undergo a pyrolysis or burnout process where the binder may be removed during sintering or annealing. This can occur where the thermal energy applied to a green body part or article removes inorganic or organic volatiles and/or other materials that may be present either by decomposition or by burning the binding agent. In other examples, if the binder includes a metal, such as a reducible metal compound, the metal binder may remain with the heat-fused article after sintering or annealing.

The binder can be included, as mentioned, in a liquid vehicle for application to the particulate build material. For example, the binder can be present in the binding agent at from about 1 wt % to about 50 wt %, from about 2 wt % to about 30 wt %, from about 5 wt % to about 25 wt %, from about 10 wt % to about 20 wt %, from about 7.5 wt % to about 15 wt %, from about 15 wt % to about 30 wt %, from about 20 wt % to about 30 wt %, or from about 2 wt % to about 12 wt % in the binding agent.

In one example, the binder can include polymer particles, such as latex polymer particles. The polymer particles can have an average particle size that can range from about 100 nm to about 1 μm. In other examples, the polymer particles can have an average particle size that can range from about 150 nm to about 300 nm, from about 200 nm to about 500 nm, or from about 250 nm to 750 nm.

In one example, the latex particles can include any of a number of copolymerized monomers, and may in some instances include a copolymerized surfactant, e.g., polyoxyethylene compound, polyoxyethylene alkylphenyl ether ammonium sulfate, sodium polyoxyethylene alkylether sulfuric ester, polyoxyethylene styrenated phenyl ether ammonium sulfate, etc. The copolymerized monomers can be from monomers, such as styrene, p-methyl styrene, α-methyl styrene, methacrylic acid, acrylic acid, acrylamide, methacrylamide, 2-hydroxyethyl acrylate, 2-hydroxyethyl methacrylate, 2-hydroxypropyl acrylate, 2-hydroxypropyl methacrylate, methyl methacrylate, hexyl acrylate, hexyl methacrylate, butyl acrylate, butyl methacrylate, ethyl acrylate, ethyl methacrylate, 2-ethylhexyl acrylate, 2-ethylhexyl methacrylate, propyl acrylate, propyl methacrylate, octadecyl acrylate, octadecyl methacrylate, stearyl methacrylate, vinylbenzyl chloride, isobornyl acrylate, tetrahydrofurfuryl acrylate, 2-phenoxyethyl methacrylate, benzyl methacrylate, benzyl acrylate, ethoxylated nonyl phenol methacrylate, ethoxylated behenyl methacrylate, polypropyleneglycol monoacrylate, isobornyl methacrylate, cyclohexyl methacrylate, cyclohexyl acrylate, t-butyl methacrylate, n-octyl methacrylate, lauryl methacrylate, tridecyl methacrylate, alkoxylated tetrahydrofurfuryl acrylate, isodecyl acrylate, isobornyl methacrylate, isobornyl acrylate, dimethyl maleate, dioctyl maleate, acetoacetoxyethyl methacrylate, diacetone acrylamide, N-vinyl imidazole, N-vinylcarbazole, N-vinyl-caprolactam, or combinations thereof. In some examples, the latex particles can include an acrylic. In other examples, the latex particles can include 2-phenoxyethyl methacrylate, cyclohexyl methacrylate, cyclohexyl acrylate, methacrylic acid, combinations thereof, derivatives thereof, or mixtures thereof. In another example, the latex particles can include styrene, methyl methacrylate, butyl acrylate, methacrylic acid, combinations thereof, derivatives thereof, or mixtures thereof.

With respect to the liquid vehicle, binding agent can include from about 50 wt % to about 99 wt %, from about 70 wt % to about 98 wt %, from about 80 wt % to about 98 wt %, from about 60 wt % to about 95 wt %, or from about 70 wt % to about 95 wt % liquid vehicle, based on the weight of the binding agent as a whole. In one example, the liquid vehicle can include water as a major solvent, e.g., the solvent present at the highest concentration when compared to other co-solvents. In another example, the liquid vehicle can further include from about 0.1 wt % to about 70 wt %, from about 0.1 wt % to about 50 wt %, or from about 1 wt % to about 30 wt % of liquid components other than water. The other liquid components can include organic co-solvent, surfactant, additive that inhibits growth of harmful microorganisms, viscosity modifier, pH adjuster, sequestering agent, preservatives, etc.

When present, organic co-solvent(s) can include high-boiling solvents and/or humectants, e.g., aliphatic alcohols, aromatic alcohols, alkyl diols, glycol ethers, polyglycol ethers, 2-pyrrolidinones, caprolactams, formamides, acetamides, C6 to C24 aliphatic alcohols, e.g., fatty alcohols of medium (C6-C12) to long (C13-C24) chain length, or mixtures thereof. The organic co-solvent(s) in aggregate can be present from 0 wt % to about 50 wt % in the binding agent. In other examples, organic co-solvents can be present at from about 5 wt % to about 25 wt %, from about 2 wt % to about 20 wt %, or from about 10 wt % to about 30 wt % in the binding agent.

### Particulate Build Materials

The particulate build material 200 can include from about 80 wt % to 100 wt %, from about 90 wt % to 100 wt %, from about 95 wt % to 100 wt %, or from about 99 wt % to 100 wt % stainless steel particles 210 (and in some instances 220) having a D50 particle size from about 5 μm to about 125 μm, from about 10 μm to about 100 μm, or from about 5 μm to about 75 μm. As used herein, particle size can refer to a value of the diameter of spherical particles or in particles that are not spherical can refer to the equivalent spherical diameter of that particle. The particle size can be in a Gaussian distribution or a Gaussian-like distribution (or normal or normal-like distribution). Gaussian-like distributions are distribution curves that can appear Gaussian in distribution curve shape, but which can be slightly skewed in one direction or the other (toward the smaller end or toward the larger end of the particle size distribution range). In these or other types of particle distributions, the particle size can be characterized in one way using the 50^{th} percentile of the particle size, sometimes referred to as the “D50” particle size. For example, a D50 value of about 25 μm means that about 50% of the particles (by number) have a particle size greater than about 25 μm and about 50% of the particles have a particle size less than about 25 μm. Whether the particle size distribution is Gaussian, Gaussian-like, or otherwise, the particle size distribution can be expressed in terms of D50 particle size, which may usually approximate average particle size, but may not be the same. In examples herein, the particle size ranges can be modified to “average particle size,” providing sometimes slightly different size distribution ranges.

About 75 wt % to 100 wt %, from about 85 wt % to 100 wt %, from about 90 wt % to 100 wt %, from about 95 wt % to 100 wt %, or from about 99 wt % to 100 wt % of the stainless steel particles can be austenitic stainless steel particles. The austenitic stainless steel particles can include from about 10 wt % to about 12.3 wt %, from about 10 wt % to about 12 wt %, from about 10 wt % to about 11.5 wt %, from about 10 wt % to about 11 wt %, from about 10.2 wt % to about 12 wt %, or from about 10.2 wt % to about 11 wt % nickel. The austenitic stainless steel particles can likewise include about 10 wt % to about 20 wt %, from about 15 wt % to about 19 wt %, or from about 16 wt % to about 18 wt % chromium. The austenitic stainless steel particles can likewise include from about 1.5 wt % to about 4 wt %, from about 2 wt % to about 3.5 wt %, or from about 2 wt % to about 3 wt % molybdenum. The austenitic stainless steel particles can likewise include up to about 0.08 wt % or up to about 0.03 wt % carbon. For example, the carbon content can be from 0 wt % to about 0.08 wt %, from 0 wt % to about 0.03 wt %, from about 0.005 wt % to about 0.08 wt %, from about 0.005 to about 0.03 wt %, from about 0.01 wt % to about 0.08 wt %, from about 0.01 to about 0.03 wt %, from about 0.01 wt % to about 0.07 wt %, from about 0.01 wt % to about 0.06 wt %, from about 0.02 wt % to about 0.06 wt %, or from about 0.005 wt % to about 0.05 wt %. In some examples, all of the stainless steel particles can be austenitic stainless steel particles. As used herein, “austenitic” refers to an atomic arrangement that is a face-centered cubic crystal with one atom at each corner of the crystal cube and one atom in the middle of each face of the crystal cube.

The nickel content can contribute to a crystal structure of the stainless steel particles. Stainless steel particles with a nickel content from about 10 wt % to about 12.3 wt % can have a face-centered cubic crystal structure and can be austenitic stainless steel. As used herein, when referring to nickel content, this refers to an actual nickel content by weight in the austenitic stainless steel by weight, and does not refer to the equivalent nickel content, which is a theoretical nickel content calculated based on the stabilizing effect of nickel and other components that also stabilize the austenitic stainless steel. Thus, the austenitic stainless steel particles of the present disclosure can have an equivalent nickel content from about 10 wt % to about 15.5 wt %, from about 10.2 wt % to about 15.5 wt %, from about 10 wt % to about 15 wt %, from about 10.2 wt % to about 15 wt %, from about 10 wt % to about 14.5 wt %, from about 10.2 wt % to about 14.5 wt %, from about 10 wt % to about 14 wt %, or from about 10.2 to about 14 wt %, for example.

In further detail regarding “equivalent nickel content,” this theoretical weight percentage value of the stabilizing effect of various components in the austenitic stainless steel particles can be determined based on the Schaeffler and Delong equivalent nickel content calculation, In that calculation, components that may have a stabilizing effect on the austenitic stainless steel particles are used to calculate their stabilizing effect relative to the stabilizing effect of nickel, and thus, an equivalent theoretical content of nickel's stabilizing effect is calculated. The equivalent nickel content may be similar to the actual nickel content, or may be different, depending on the other components that may be present in the austenitic stainless steel. The formula used to calculate the equivalent nickel content (expressed in wt %) is shown in Formula I, as follows:

$$Wt \% Nickel + Wt \% Cobalt + 0.5 ( Wt \% Manganese ) + 0.3 ( Wt \% Copper ) + 25 ( Wt \% Nitrogen ) + 30 ( Wt \% Carbon ) = Equivalent Nickel Content \qquad Formula I$$

In practice, and using statistical modeling for validation, many stainless steels having from about 10 wt % to about 12.3 wt % nickel content can be prepared that also have from about 10 wt % to about 15.5 wt % equivalent nickel content. There are many stainless steels, on the other hand, that would have a higher equivalent nickel content, such as stainless steels with high carbon content, high nitrogen content, or high content of some of the other metals described above.

In other examples, the austenitic stainless steel particles can include from 0 wt % to about 2 wt % or from about 0.01 wt % to about 2 wt % manganese, from 0 wt % to about 1 wt % or from about 0.01 wt % to about 0.7 wt % cobalt, from 0 wt % to about 0.05 wt % or from about 0.01 wt % to about 0.08 wt % nitrogen, and/or from 0 wt % to about 2 wt % or from about 0.01 wt % to about 2 wt % silicon.

In some examples, blended with the austenitic stainless steel particles, there may be other types of stainless steel particles, or even particles of other metal or ceramic materials. For example, in addition to the austenitic stainless steel particles, if included, ferritic steel grains, martensitic steel grains, amorphous steel grains, or a combination thereof, in addition to the austenitic stainless steel particles, may be included or blended with the austenitic stainless steel particles (based on a total weight of the stainless steel particles) at from about 0.1 wt % to about 10 wt %, from about 1 wt % to about 10 wt %, from about 2 wt % to about 10 wt %, from about 0.1 wt % to about 5 wt %, from about 0.1 wt % to about 3 wt %, or from about 0.1 wt % to about 2 wt %. As used herein, “ferritic” steels can have an atomic arrangement that is a body-centered cubic grain structure with a cubic atom cell that includes one atom in the center.

As mentioned, the carbon content can be relatively low in the austenitic steel particles of the present disclosure. For example, the austenitic stainless steel particles can have what is sometimes referred to as an “extra low carbon content,” e.g., less than about 300 ppm by weight or less than about 0.03 wt % carbon content. An example of such material is designated in the industry as 316L stainless steel particles. In other examples, the austenitic stainless steel can be a “low carbon content” stainless steel, e.g., from about 300 ppm to about 800 ppm by weight or from about 0.03 wt % to about 0.08 wt % carbon content. As mentioned, if carbon is present, in one example, the austenitic stainless steel particles can have from about 0.005 wt % to about 0.08 wt % carbon or from about 0.005 wt % to about 0.03 wt % carbon. Stainless steel particles with low carbon content, or particularly extra low carbon content, can exhibit corrosion resistance and can be stronger than comparable stainless steel particles that incorporate a higher carbon content in the context of forming metal articles in accordance with the three-dimensional printing and fusing technologies described herein.

The stainless steel particles can be spherical, irregular spherical, rounded, semi-rounded, discoidal, angular, subangular, cubic, cylindrical, or any combination thereof. In one example, stainless steel particles can include spherical particles, irregular spherical particles, or rounded particles. In some examples, the shape of the stainless steel particles can be uniform, which can allow for relatively uniform melting or sintering of the particles.

### Three-Dimensional Printing Systems

In further detail, a three-dimensional (3D) printing system is shown at 300 in FIG. 2, and can include a binding agent 100 and a particulate build material 200, as shown and described in FIG. 1 at 10, for example, and can further include a fluid applicator 310. In this example, the fluid applicator is shown on a carriage track 320, but could be supported by any of a number of structures. The fluid applicator can be fluidly coupled or coupleable to the binding agent and directable to apply the binding agent to the particulate build material to form a layered green body article. The binding agent and particulate build material of the material set can be as described above with respect to the 3D printing kit.

The fluid applicator 310 can be any type of apparatus capable of selectively applying the binding agent. For example, the fluid applicator can be a fluid ejector or digital fluid ejector, such as an inkjet printhead, e.g., a piezo-electric printhead, a thermal printhead, a continuous printhead, etc. The fluid applicator could likewise be a sprayer, a dropper, or other similar structure for applying the binding agent to the particulate build material. Thus, in some examples, the application can be by jetting or ejecting from a digital fluid jet applicator, similar to an inkjet pen. In yet another example, the fluid applicator can include a motor and can be operable to move back and forth over the particulate build material along a carriage 320 when positioned over or adjacent to a powder bed of a build platform.

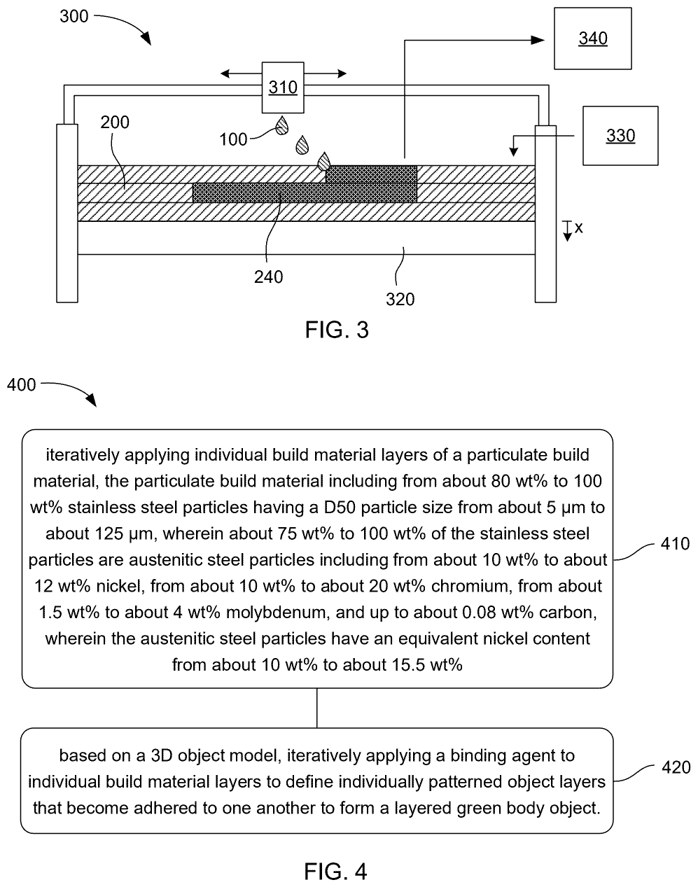

In some examples, as further illustrated in FIG. 3, in addition to the fluid applicator 310, the system 300 can further include a build platform 320 that can support a powder bed of particulate build material 200. The build platform can be positioned to receive the binding agent 100 from the fluid applicator onto the particulate build material. The build platform can be configured to drop in height (shown at “x”), thus allowing for successive layers of particulate build material to be applied by a supply and/or spreader 330. The particulate build material can be layered in the build platform at a thickness that can range from about 5 μm to about 1 cm. In some examples, individual layers can have a relatively uniform thickness. In one example, a thickness of a layer of the particulate build material can range from about 10 μm to about 500 μm, or from about 30 μm to about 200 μm. In further detail, the 3D printing system can further include a fusing oven 340 to receive and heat the green body article 240 (formed from the particulate build material with binding agent applied thereto) and to form a heat-fused article. In some examples, the fusing oven can likewise be used to pre-heat the green body object prior to heat-fusing, at a temperature from about 300° C. to about 600° C., or alternatively, the pre-heating can occur using a separate heater, or while the green body article is still resting on the build platform (within the particulate build material or after removal of the loose particulate build material).

### Three-Dimensional Printing Methods

A flow diagram of an example method 400 of three-dimensional (3D) printing is shown in FIG. 4. The method can include iteratively applying 410 individual build material layers of a particulate build material, and based on a 3D article model, iteratively applying 420 a binding agent to individual build material layers to define individually patterned article layers that become adhered to one another to form a layered green body article. The particulate build material can include from about 80 wt % to 100 wt % stainless steel particles having a D50 particle size from about 5 μm to about 125 μm. About 75 wt % to 100 wt % of the stainless steel particles can be austenitic stainless steel particles including from about 10 wt % to about 12.3 wt % nickel, from about 10 wt % to about 20 wt % chromium, from about 1.5 wt % to about 4 wt % molybdenum, and up to about 0.08 wt % carbon. The austenitic stainless steel particles can have an equivalent nickel content from about 10 wt % to about 15.5 wt %. The green body article can have a porosity ranging from about 38% to about 50% by volume. Porosity of the three-dimensional article can be determined by water displacement. The method can further include heat-fusing the green body article to achieve a density of from about 95 wt % to 100 wt %, from about 95 wt % to about 98 wt %, or from about 97 wt % to 100 wt %, for example.

In printing in a layer-by-layer manner, the particulate build material can be spread, the binding agent applied, and then the build platform can then be dropped a distance of (x), which can correspond to the thickness of a printed layer of the green body article, so that another layer of the particulate build material can be added again thereon to receive another application of binding agent, and so forth. This process can be repeated on a layer by layer basis until the entire green body article is formed. During the build, in one example, heat can be applied from overhead and/or can be provided by the build platform from beneath the particulate build material to drive off water and/or other liquid components, as well as to further solidify the layer of the green body article. In other examples, the particulate build material can be heated prior to dispensing. After the green body article or portion thereof is formed, in some instances, the method can include heating the green body article to within a temperature ranging from about 150° C. to about 600° C., from about 200° C. to about 400° C., or from about 300° C. to about 600° C. for a time period ranging from about 5 minutes to about 20 hours prior to sintering the green body article.

Following the formation of the green body article, the entire green body article can be moved to an oven and fused by sintering and/or annealing. The heat-fusion temperatures and temperature profiles used can vary (within a heat-fusing temperature range, using any of a number of heat ramp up and/or cooling ramp down profiles, etc.), depending on the particle size. In one example, the sintering temperature can range from about 10° C. below the melting temperature of the stainless steel particles of the particulate build material to about 50° C. below the melting temperature of the stainless steel particles of the particulate build material. If there are multiple types of stainless steel particles present, e.g., austenitic stainless steel and ferritic steel grain, then these ranges can be based on melting temperature of the austenitic stainless steel particles, since those type of particles make up the bulk of the metal particles present in the particulate build material. The sintering temperature can also depend upon a period of time that heating occurs, e.g., at an elevated temperature for a sufficient time to cause particle surfaces to become physically merged or composited together. In one example, sintering of the green body article can occur at a temperature ranging from about 1,250° C. to about 1,430° C. for a time period ranging from about 10 minutes to about 10 hours to fuse the metal particles together and form a fused three-dimensional article. In some examples, the temperature can range from about 1,300° C. to about 1,420° C., from about 1,300° C. to about 1,400° C., or from about 1,250° C. to about 1,400° C. The heat can be used to melt an outer layer of the stainless steel particles and can permit sintering of the stainless steel particles to one another, while not melting an inner portion of the stainless steel particles.

### Definitions

It is noted that, as used in this specification and the appended claims, the singular forms “a,” “an,” and “the” include plural referents unless the content clearly dictates otherwise.

The term “about” as used herein, when referring to a numerical value or range, allows for a degree of variability in the value or range, for example, within 10%, or, in one aspect within 5%, of a stated value or of a stated limit of a range. The term “about” when modifying a numerical range is also understood to include as one numerical subrange a range defined by the exact numerical value indicated, e.g., the range of about 1 wt % to about 5 wt % includes 1 wt % to 5 wt % as an explicitly supported sub-range.

As used herein, the “green” is used to describe any of a number of intermediate structures prior to particle to particle material fusing, e.g., green part, green body, green body article, green body layer, etc. As a “green” structure, the particulate build material can be (weakly) bound together by a binder. Typically, a mechanical strength of the green body is such that the green body can be handled or extracted from a particulate build material on build platform to place in a fusing oven, for example. It is to be understood that any particulate build material that is not patterned with the binding agent is not considered to be part of the “green” structure, even if the particulate build material is adjacent to or surrounds the green body article or layer thereof. For example, unprinted particulate build material can act to support the green body while contained therein, but the particulate build material is not part of the green structure unless the particulate build material is printed with a binding agent or some other fluid that is used to generate a solidified part prior to fusing, e.g., sintering, annealing, melting, etc.

As used herein, “kit” can be synonymous with and understood to include a plurality of compositions including multiple components where the different compositions can be separately contained (though in some instances co-packaged in separate containers) prior to use, but these components can be combined together during use, such as the 3D article build processes described herein. The containers can be any type of a vessel, box, or receptacle made of any material.

The term “fuse,” “fusing,” “fusion,” or the like refers to the joining of the material of adjacent particles of a particulate build material, such as by sintering, annealing, melting, or the like, and can include complete fusing of adjacent particles into a common structure, e.g., melting together, or can include surface fusing where particles are not fully melted to a point of liquefaction, but which allow for individual particles of the particulate build material to become bound to one another, e.g., forming material bridges between particles at or near a point of contact.

As used herein, “applying” when referring to binding agent or other fluid agents that may be used, for example, refers to any technology that can be used to put or place the fluid agent, e.g., binding agent, on the particulate build material or into a layer of particulate build material for forming a green body article. For example, “applying” may refer to “jetting,” “ejecting,” “dropping,” “spraying,” or the like.

As used herein, “jetting” or “ejecting” refers to fluid agents or other compositions that are expelled from ejection or jetting architecture, such as ink-jet architecture. Ink-jet architecture can include thermal or piezoelectric architecture. Additionally, such architecture can be configured to print varying drop sizes such as up to about 20 picoliters, up to about 30 picoliters, or up to about 50 picoliters, etc. Example ranges may include from about 2 picoliters to about 50 picoliters, or from about 3 picoliters to about 12 picoliters.

As used herein, a plurality of items, structural elements, compositional elements, and/or materials may be presented in a common list for convenience. However, these lists should be construed as though the individual member of the list is identified as a separate and unique member. Thus, no individual member of such list should be construed as a de facto equivalent of any other member of the same list based on presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, as well as to include all the individual numerical values or sub-ranges encompassed within that range as the individual numerical value and/or sub-range is explicitly recited. For example, a weight ratio range of about 1 wt % to about 20 wt % should be interpreted to include the explicitly recited limits of 1 wt % and 20 wt % and to include individual weights such as about 2 wt %, about 11 wt %, about 14 wt %, and sub-ranges such as about 10 wt % to about 20 wt %, about 5 wt % to about 15 wt %, etc.

### EXAMPLE

The following illustrates an example of the present disclosure. However, it is to be understood that the following is only illustrative of the application of the principles of the present disclosure. Numerous modifications and alternative compositions, methods, and systems may be devised without departing from the present disclosure. The appended claims are intended to cover such modifications and arrangements.

An experiment was designed to evaluate the equivalent nickel content as it related to heat-fused article density in accordance with the present disclosure. Several heat-fused 3D articles were prepared using a layer-by-layer powder bed printing process, such as that shown by example in FIGS. 2-4. Specifically, ten (10) different particulate build material formulations were compared to determine article density after heat fusion. For this example, all of the particulate build materials selected for use included from 97 wt % to 99.8 wt % stainless steel particles. The build process was as follows for the various parts prepared:
1) Particulate build material is spread evenly on a build platform at an average thickness of about 70 μm to form a build material layer.
2) Fusing agent including latex binder is selectively applied to portions of the build material layer at a latex polymer particle to particulate build material weight ratio of about 1:99.
3) The spreading of the particulate build material (1) and the application of the fusing agent (2) is then repeated until a green body object is formed having multiple layers
4) The green body object is then removed from the particulate build material that is not part of the green body object and then heated, e.g., pre-heated to about 400° C. for 240 minutes, causing the binder particles to decompose, and then continuing to raise the temperature to fusing the stainless steel metal particles together at about 1380° C. for 120 minutes.
5) Following controlled cooling, a heat-fused stainless steel article remains.

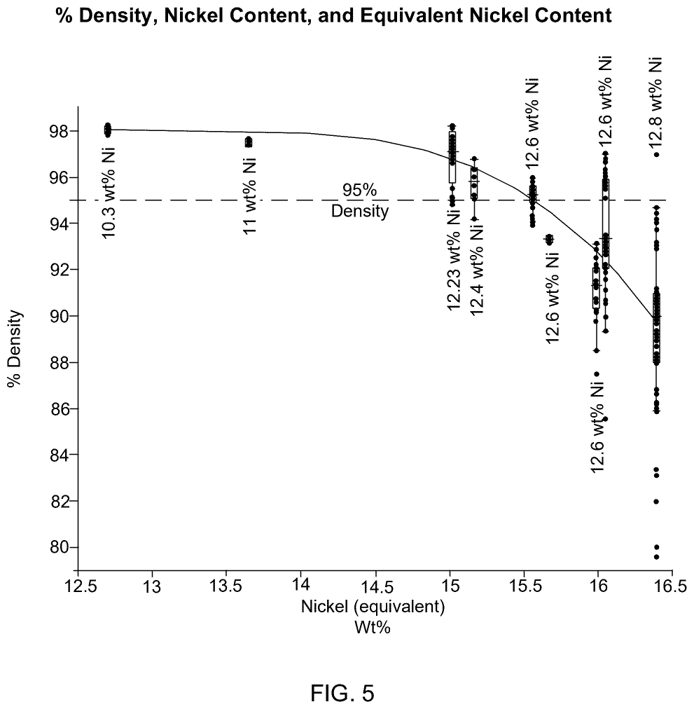

For this experiment, the target density was set at about 95% of theoretical density, which provides a heat-fused article with good mechanical properties compared to articles below this target density threshold. Of the ten (10) different particulate build materials evaluated (evaluated from multiple samples from the same batch, as shown in FIG. 5), the stainless steel particles having an equivalent nickel content less than about 15.5 wt % and an actual nickel content from about 10 wt % to about 12 wt % exhibited an article density of about 95% or greater, e.g., ≥95% or 7.6 gm/cm³ in all instances across multiple samples tested. There were a few samples, e.g., below about 12.3 wt % nickel that provided most samples exceeding 95% density, with only minimal outliers just barely below 95% density.

1.-10. (canceled)

11. A method of three-dimensional printing, the method comprising:
iteratively applying individual build material layers of a particulate build material including from about 80 wt % to 100 wt % of stainless steel particles having a D50 particle size of from about 5 μm to about 125 μm, wherein about 75 wt % to 100 wt % of the stainless steel particles include austenitic stainless steel particles including:
from about 10 wt % to about 12.3 wt % of nickel;
from about 10 wt % to about 20 wt % of chromium;
from about 1.5 wt % to about 4 wt % of molybdenum;
up to about 0.08 wt % of carbon;
from 0 wt % to about 2 wt % of manganese;
from 0 wt % to about 1 wt % of cobalt;
from 0 wt % to about 0.08 wt % of nitrogen;
from 0 wt % to about 2 wt % of silicon; and
a balance of iron,
wherein the austenitic stainless steel particles have an equivalent nickel content of from about 10 wt % to about 15.5 wt %;
based on a 3D article model, iteratively applying a binding agent to individual build material layers to define individually patterned article layers that become adhered to one another to form a layered green body article; and
heat fusing the layered green body article by heating the layered green body article to a temperature ranging from about 1,250° C. to about 1,430° C. for a time period ranging from about 10 minutes to about 10 hours to form a fused three-dimensional article.

12. The method of claim 11, wherein the green body article has a porosity that ranges from about 38% to about 50% by volume.

13. (canceled)

14. The method of claim 11, wherein the fused three-dimensional article has a density of from about 95 wt % to 100 wt %.

15. The method of claim 11, further comprising pre-heating the layered green body article to a temperature ranging from about 300° C. to about 600° C. for a time period ranging from about 5 minutes to 20 hours prior to the heat fusing of the layered green body article.

16. The method of claim 15, wherein the pre-heating includes pre-heating the layered green body article to a temperature of from about 300° C. to about 400° C. for a time period ranging from about 5 minutes to 240 minutes.

17. The method of claim 15, further comprising placing the layered green body article into a fusing oven, wherein both the pre-heating and the heat fusing take place within the fusing oven.

18. The method of claim 11, wherein the heat fusing includes heating the layered green body article to a temperature of about 1,300° C. to about 1,400° C. for about 10 minutes to 120 minutes to form a fused three-dimensional article.

19. The method of claim 11, wherein the particulate build material includes from 97 wt % to 99.8 wt % of the stainless steel particles.

20. The method of claim 11, wherein the stainless steel particles further include from 0.1 wt % to 10 wt % of ferritic steel grains, martensitic steel grains, amorphous steel grains, or a combination thereof.

21. The method of claim 11, wherein the binder agent includes:
from about 2 wt % to about 30 wt % of latex polymer particles; and
a liquid vehicle.

22. The method of claim 11, wherein the stainless steel particles have a D50 particle size of from about 5 μm to about 75 μm.
